(19) United States
(12) Patent Application Publication
(10) Pub. No.: US 2026/0119119 A1
(43) Pub. Date: Apr. 30, 2026

(54) AUDIO PROCESSING DEVICE AND METHOD AND ELECTRONIC DEVICE

(71) Applicant: Lenovo (Beijing) Limited, Beijing (CN)

(72) Inventor: Xiansong XIONG, Beijing (CN)

(21) Appl. No.: 19/370,224

(22) Filed: Oct. 27, 2025

(30) Foreign Application Priority Data
Oct. 31, 2024 (CN) 202411547892.7

(51) Int. Cl. G06F 3/16; A63F 13/54; A63F 13/837; G10L 15/02; G10L 15/06; G10L 15/183; G10L 25/51

(52) U.S. Cl. CPC G06F 3/165; A63F 13/54; G06F 3/162; G10L 15/02; G10L 15/063; G10L 15/183; G10L 25/51; A63F 13/837

(57) ABSTRACT

An audio processing device includes obtaining a first audio to be output by an application program at a current time; identifying a second audio and a background audio in the first audio at the current time, the second audio including a target audio generated by simulating a target object; processing the target audio in the second audio at the current time to obtain a third audio at the current time; and outputting the background audio and the third audio at the current time, the target audio before processing having a first audio intensity, the target audio after processing having a second audio intensity, the second audio intensity being greater than the first audio intensity.

### CROSS-REFERENCES TO RELATED APPLICATION

This application claims priority to Chinese Patent Application No. 202411547892.7 filed on Oct. 31, 2024, the entire content of which is incorporated herein by reference.

### FIELD OF TECHNOLOGY

The present disclosure relates to the field of audio processing technology and, more specifically, to an audio processing device and method, and an electronic device.

### BACKGROUND

With the continuous development of audio technology, various common audio signals can be adjusted. For example, the parameters of the equalization mode when the sound is played can be set in the system settings of the device to adjust the audio. In addition, the audio of an application can be adjusted by setting the audio parameters in the application.

In practice, there is a need to adjust a specific audio in the audio to be played. For example, in shooting games, in order to clearly perceive the enemy's position, there is a need to enhance the sound of footsteps or gunshots. Often, the audio can only be adjusted as a whole, but a user cannot enhance a specific sound (such as footsteps or gunshots) in the audio being played.

### SUMMARY

One aspect of this disclosure provides an audio processing method. The method includes obtaining a first audio to be output by an application program at a current time; identifying a second audio and a background audio in the first audio at the current time, the second audio including a target audio generated by simulating a target object; processing the target audio in the second audio at the current time to obtain a third audio at the current time; and outputting the background audio and the third audio at the current time. The target audio before processing has a first audio intensity, the target audio after processing has a second audio intensity, and the second audio intensity is greater than the first audio intensity.

Another aspect of this disclosure provides an audio processing device. The device includes an acquisition unit, a recognition unit, a processing unit, and an output unit. The acquisition unit is configured to obtain a first audio at the current time to be output by an application program. The recognition unit is configured to identify a second audio and a background audio in the first audio at the current time, the second audio includes a target audio generated by simulating a target object. The processing unit is configured to process the target audio in the second audio at the current time to obtain a third audio at the current time. The output unit is configured to output the background audio and the third audio at the current time. The target audio before processing has a first audio intensity, the target audio after processing has a second audio intensity, and the second audio intensity is greater than the first audio intensity.

Another aspect of this disclosure provides an electronic device. The electronic device includes first interface, a processor, and an output interface. The first input is configured to obtain a first audio at the current time to be output by an application program. The processor is configured to identify a second audio and a background audio in the first audio at the current time, and process the target audio in the second audio at the current time to obtain a third audio at the current time. The second audio includes a target audio generated by simulating a target object. The output interface is configured to output the background audio and the third audio at the current time. The target audio before processing has a first audio intensity, the target audio after processing has a second audio intensity, and the second audio intensity is greater than the first audio intensity.

### BRIEF DESCRIPTION OF THE DRAWINGS

FIG. 1 is a flowchart of an audio processing method according to some embodiments of the present disclosure.

FIG. 2 is a flowchart of the audio processing method according to some embodiments of the present disclosure.

FIG. 3 is a flowchart of the audio processing method according to some embodiments of the present disclosure.

FIG. 4 is a flowchart of the audio processing method according to some embodiments of the present disclosure.

FIG. 5 is a flowchart of the audio processing method according to some embodiments of the present disclosure.

FIG. 6 is a flowchart of the audio processing method according to some embodiments of the present disclosure.

FIG. 7 is a flowchart of an audio processing process according to some embodiments of the present disclosure.

FIG. 8 is a schematic diagram of a detection process according to some embodiments of the present disclosure.

FIG. 9 is a schematic diagram of an audio enhancement process according to some embodiments of the present disclosure.

FIG. 10 is a schematic diagram of a filtering process according to some embodiments of the present disclosure.

FIG. 11 is a schematic structural diagram of an audio processing device according to some embodiments of the present disclosure.

FIG. 12 is a schematic diagram of an electronic device according to some embodiments of the present disclosure.

### DETAILED DESCRIPTION

To make the purposes, technical solutions, and advantages of the present disclosure clearer, the present disclosure is described in detail in connection with the accompanying drawings. The described embodiments should not be considered to limit the scope of the present disclosure. All other embodiments obtained by those skilled in the art without creative efforts are within the scope of the present disclosure.

In the following description, the term “some embodiments” describes a subset of all possible embodiments. “Some embodiments” can be a same subset or different subsets of all possible embodiments and can be combined with each other when there is no conflict.

In the following description, the terms “first,” “second,” and “third” are merely used to distinguish similar objects and do not represent a specific order. The terms “first,” “second,” and “third” can be interchanged in a specific sequence or order. Thus, embodiments of the present disclosure can be implemented in an order other than the order shown or described here.

Unless otherwise defined, all technical and scientific terms of the present disclosure have the same meanings as commonly understood by those skilled in the art. The terms used in the present disclosure are merely for the purpose of describing embodiments of the present disclosure and are not intended to limit the present disclosure.

Embodiments of the present disclosure provide an audio processing method, apparatus, device, storage medium and computer program product. In practical applications, the audio processing method can be implemented by an audio processing device. Each functional entity in the audio processing device can be collaboratively implemented by the hardware resources of the electronic device, such as computing resources such as processors, and communication resources (such as those used to support various communication methods such as optical cables and cellular networks).

An embodiment of the present disclosure provides an audio processing method, which can be applied to electronic devices.

The embodiments of the present disclosure do not limit the specific type of electronic device, which can be configured based on actual needs. For example, the electronic device may include, but is not limited to, a mobile phone, a tablet computer, a smart wearable device (such as a smart watch, a pair of smart glasses, etc.) or a computer.

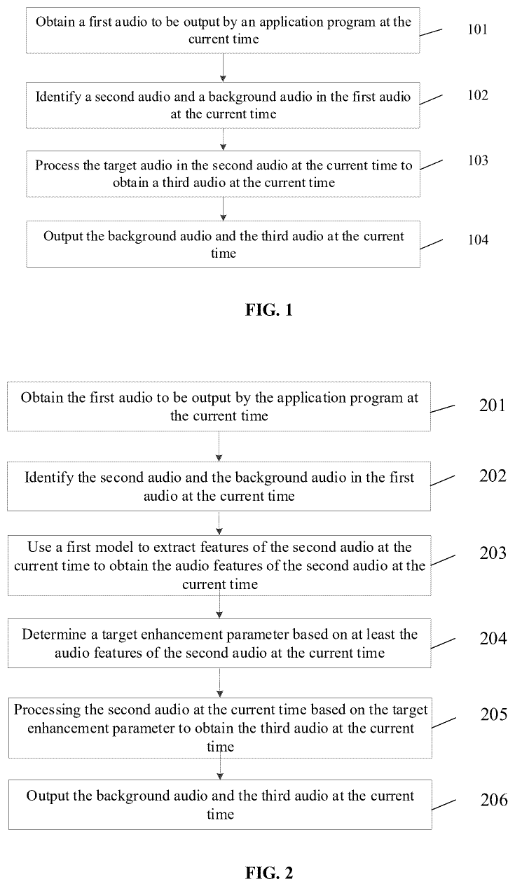

FIG. 1 is a flowchart of an audio processing method according to some embodiments of the present disclosure. The method will be described in detail below.
101, obtaining a first audio to be output by an application program at the current time.

The embodiments of the present disclosure do not limit the application programs herein, which can be configured based on actual needs. For example, the application program may be a shooting game, a fighting game, etc.

In some embodiments, the first audio may be the audio that the application program is currently outputting.

In some embodiments, the first audio may include a target audio, an ambient audio (e.g., sound of raindrops, sound of thunder, etc.), and a background audio.

In some embodiments, the target audio may be the audio that needs to be enhanced. The target audio can be configured based on actual needs. For example, the target audio may include, but is not limited to, sound of gunshot, footsteps, explosion, etc.

During implementation, the process at 101 can be implemented as the electronic device calling the first audio signal at the current time to be output by the application program through an audio output interface.
102, identifying a second audio and a background audio in the first audio at the current time.

In some embodiments, the second audio may include the target audio generated by simulating a target object. For example, the second audio may be an audio that simulates a gunshot or simulates footsteps in a game application.

The embodiments of the present disclosure do not limit the identification method, which can be configured based on actual needs. For example, the identification can be performed using a binary classification model. Of course, the identification can also be performed using other algorithms (such as the Mel spectrum energy algorithm), which will not be described in detail here.

In some embodiments, the second audio may be the audio in the first audio other than the background audio, which can also be referred to the content audio.

In some embodiments, the first audio can be input into a neural network binary classification model, and the first audio is identified by the neural network binary classification model to obtain the second audio and background audio.

The neural network binary classification model may be a pre-trained neural network for distinguishing between background audio and non-background audio. The specific training process will not be described in detail here.
103, processing the target audio in the second audio at the current time to obtain a third audio at the current time.

In some embodiments, the target audio before processing may include a first audio intensity, and the target audio after processing may include a second audio intensity. The second audio intensity may be greater than the first audio intensity.

In some embodiments, the second audio may include the target audio before processing, and the third audio may include the target audio after processing. The second audio and the third audio here are a general term. For audios at different times, there will be different second audios and different third audios at different times.

The second audio intensity can be configured based on actual needs. For example, the second audio intensity may be configured based on the type of target audio. For different types of target audio, the same or different second audio intensities may be configured. For example, a second audio intensity can be configured for gunshots and another second audio intensity can be configured for footsteps. In practice, different second audio intensities may be configured for different types of gunshots (e.g., pistols, sniper rifles, etc.), and different second audio intensities may be configured for different types of footsteps (e.g., walking, running, etc.).

The embodiments of the present disclosure do not limit the method of processing the target audio in the second audio at the current time, which can be configured based on actual needs. During the process of processing the second audio, the purpose is to enhance the target audio and keep other audios unchanged.
104, outputting the background audio and the third audio at the current time.

The third audio at the current time and the background audio can be output. In some embodiments, the background audio and the third audio can be output through their respective original output channels.

It should be noted that, in some embodiments, when the application program is a shooting game, the target audio that needs to be enhanced may be the target audio of enemies and teammates in the game, that is, other objects other the user.

Consistent with the present disclosure, the audio processing method includes obtaining the first audio to be output by the application program at the current time, identifying the second audio and the background audio in the first audio at the current time, the second audio including the target audio generated by simulating a target object, processing the target audio in the second audio at the current time to obtain the third audio at the current time, and outputting the background audio and the third audio at the current time. The target audio before processing can include a first audio intensity, and the target audio after processing can include a second audio intensity, which can be greater than the first audio intensity.

In practice, the target audio in the second audio is generally fused with other audio, and the target audio cannot be directly enhanced. In this case, the second audio may be processed such that the target audio is enhanced from the first audio intensity to the second audio intensity, while other audio in the second audio remains unchanged as much as possible, thereby enhancing the target audio in the second audio.

The following is an example to describe the audio processing method described above.

Assume that the application program is a shooting game. The user plays the game based on different operations on a mobile phone. During the game, audio needs to be output continuously. In different scenarios, the output audio is different. In this example, the gunshot sounds to be outputted by various objects (enemies or teammates) in the game need to be enhanced such that the user can immediately determine the position of the enemy or teammate based on the gunshot sounds.

The mobile phone obtains the first audio to be output at the current time through the audio output interface. Assume that the first audio includes background audio, sound of gunshots, sound of raindrops, etc., the first audio can be identified to obtain the second audio (e.g., sound of gunshots, raindrops, etc.) and the background audio. Then the second audio can be processed such that the gunshot sounds in the second audio is enhanced from the first audio intensity to the second audio intensity, and the audio such as the sound of raindrops is kept at the original audio intensity as much as possible to highlight the sound of gunshots.

In this way, after outputting the background audio and the third audio (i.e., the sound of gunshots and raindrops at the second audio intensity), the user can clearly perceive the sound of gunshots, thereby further perceiving the position of the enemies or teammates who made the shot.

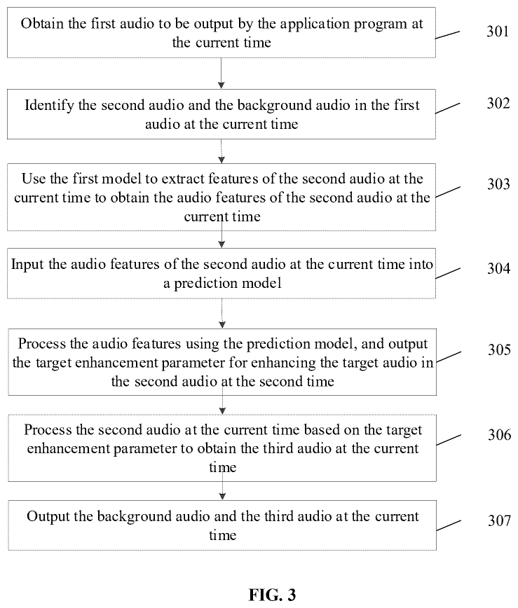

FIG. 2 is a flowchart of the audio processing method according to some embodiments of the present disclosure. The method will be described in detail below.
201, obtaining the first audio to be output by an application program at the current time.

For the implementation of the process at 201, reference can be made to the description of the process at 101, which will not be repeated here.
202, identifying the second audio and the background audio in the first audio at the current time.

For the implementation of the process at 202, reference can be made to the description of the process at 102, which will not be repeated here.
203, using a first model to extract features of the second audio at the current time to obtain the audio features of the second audio at the current time.

In some embodiments, a first model can be used for feature extraction, that is, to convert audio information into feature vectors. The embodiments of the present disclosure do not limit the structure of the first model, which can be configured based on actual needs. For example, the first model can be a neural network model or a large language model.

The first model may only extract features, that is, the audio information included in the second audio will be the audio features included in the second audio after the first model extracts these features.

For example, when the second audio includes the target audio, the audio features of the second audio can include the audio features of the target audio. When the second audio includes the target audio and the ambient audio, the audio features of the second audio can include the audio features of the target audio and the audio features of the ambient audio. Since the first model only has a feature extraction function but no identification function, the audio features of the target audio and the audio features of the ambient audio can be fused features.
204, determining a target enhancement parameter based on at least the audio features of the second audio at the current time.

The target enhancement parameter may be used to enhance the target audio in the second audio at the current time from the first audio intensity to the second audio intensity. For example, the target enhancement parameter may be the parameter in the equalization filter.

In some embodiments, the target enhancement parameter may be determined based on the audio features of the second audio at the current time.

In some embodiments, the target enhancement parameter may be determined based on the audio features of the second audio at the current time and the historical second audio and the historical third audio.

The embodiments of the present disclosure do not limit the type of the target enhancement parameter, which can be configured based on actual needs. For example, the target enhancement parameter may include the frequency, gain, and quality factor (Q value). The target enhancement parameter may also include the slope and cutoff frequency, etc.
205, processing the second audio at the current time based on the target enhancement parameter to obtain the third audio at the current time.
206, outputting the background audio and the third audio at the current time.

For the implementation of the process at 206, reference can be made to the description of the process at 104, which will not be repeated here.

Consistent with the present disclosure, the audio features of the second audio can be extracted first, and then the target enhancement parameter can be determined based on the audio features of the second audio. Since the target enhancement parameter is used to enhance the target audio in the second audio at the current time from the first audio intensity to the second audio intensity, the target audio can be enhanced by processing the second audio based on the target enhancement parameter.

The following describes the process of determining the target enhancement parameter based on at least the audio features of the second audio at the current time in the process at 204. This process may include, but is not limited to, the following methods.

In some embodiments, the target enhancement parameter may be determined based on a prediction model.

In some embodiments, the target enhancement parameter may be determined based on a degree of matching.

The following describes the process of determining the target enhancement parameters based on the prediction model.

FIG. 3 is a flowchart of the audio processing method according to some embodiments of the present disclosure. The method will be described in detail below.
301, obtaining the first audio to be output by an application program at the current time.

For the implementation of the process at 301, reference can be made to the description of the process at 101, which will not be repeated here.
302, identifying the second audio and the background audio in the first audio at the current time.

For the implementation of the process at 302, reference can be made to the description of the process at 102, which will not be repeated here.
303, using the first model to extract features of the second audio at the current time to obtain the audio features of the second audio at the current time.

For the implementation of the process at 303, reference can be made to the description of the process at 203, which will not be repeated here.
304, inputting the audio features of the second audio at the current time into the prediction model.

The audio features of the second audio may be the output of the first model, and the output of the first model can be input into the prediction model. Therefore, in practice, the first model and the prediction model can be two independent models, or the prediction model and the first model can be integrated into one model to achieve feature extraction and prediction using one model.
305, processing the audio features using the prediction model, and outputting the target enhancement parameter for enhancing the target audio in the second audio at the second time.

The prediction model can be used to predict the enhancement parameters corresponding to the audio features for enhancing the target audio in the second audio at the current time.

The audio features input to the prediction model can be the audio features of the second audio. The prediction model can process the audio features of the second audio and output the target enhancement parameters for enhancing the target audio in the second audio at the current time.

The prediction model can be trained to predict the enhancement parameters for enhancing the target audio in the second audio at the current time corresponding to the audio features. Different enhancement parameters may be obtained for different audio features.

The embodiments of the present disclosure do not limit the type of prediction model, which can be configured based on actual needs. For example, the prediction model can be a neural network model.

In some embodiments, the target enhancement parameters may be determined by a prediction model, and the target enhancement parameters determined by the prediction model have the characteristic of high accuracy.
306, processing the second audio at the current time based on the target enhancement parameter to obtain the third audio at the current time.

For the implementation of the process at 306, reference can be made to the description of the process at 205, which will not be repeated here.
307, outputting the background audio and the third audio at the current time.

For the implementation of the process at 307, reference can be made to the description of the process at 104, which will not be repeated here.

The following describes the prediction model.

In some embodiments, the prediction model may be trained based on the following sets of training data.

The sets of training data may include the audio features of the target audio and a first enhancement parameter, the fused audio features of the target audio and the ambient audio and a second enhancement parameter, the fused audio features of the target audio and the scene audio and a third enhancement parameter, and the fused audio features of the target audio, the ambient audio and the scene audio and a fourth enhancement parameter.

The first enhancement parameter may be a reference enhancement parameter determined by the user for pure target audio. The second enhancement parameter may be a reference enhancement parameter determined by the user for the target audio and the ambient audio. The third enhancement parameter may be a reference enhancement parameter determined by the user for the target audio and scene audio. The fourth enhancement parameter may be a reference enhancement parameter determined by the user for the target audio, scene audio, and the environment.

The environment may include, but is not limited to, various game environments, such as rain, thunder, sunny days, snowy days, storms, typhoons, sandstorms, etc. The scenes here can include, but are not limited to, various game scenes, such as deserts, grasslands, mud, prairie, lakes, mountains, swamps, etc.

In addition, the target audios can be classified in detail, and different reference enhancement parameters can be configured for different types of target audios to train the model. In this way, the prediction model can predict different target enhancement parameters for different types of target audios. For example, for different gunshot types (e.g., pistols, sniper rifles, etc.), the prediction model can predict the target enhancement parameters corresponding to pistol and the target enhancement parameters corresponding to sniper rifle.

In this way, the trained prediction model can predict different enhancement parameters when the first audio includes different audio types.

In practice, training may also be performed using at least one of the multiple sets of training data described above. For example, when the training data only includes the audio features of the target audio and the first enhancement parameter, the target enhancement parameter predicted by the trained prediction model is only the enhancement parameter applicable to the target audio scene. If the second audio also includes ambient audio, etc., the influence of the ambient audio on the enhancement parameters cannot be identified, and the target enhancement parameters adapted to the environment cannot be obtained.

The prediction model obtained by training the multiple sets of training data can predict the target enhancement parameters applicable to the target audio when the second audio includes the target audio. When the second audio includes the target audio and the scene audio, the target enhancement parameters applicable to the target audio and the scene audio can be predicted. When the second audio includes target audio and ambient audio, target enhancement parameters applicable to the target audio and ambient audio can be predicted. When the second audio includes target audio, scene audio and ambient audio, target enhancement parameters applicable to the target audio, scene audio and ambient audio can be predicted. In this way, different target enhancement parameters can be predicted for different scenes and environments.

The embodiments of the present disclosure do not limit the specific training process, which can be configured based on actual needs. For example, the training process may include inputting multiple sets of training data into the prediction model for the prediction model to output the enhancement parameters corresponding to the training data after the process is processed. The loss can be determined based on the enhancement parameter and the corresponding reference enhancement parameter, and the parameters of the prediction model can be reversely adjusted based on the loss until the loss converges, thereby obtaining a trained prediction model.

In some embodiments, the first model may be a local large language model deployed on the electronic device running the application program, the audio features of the second audio may be the embedding vector of the large language model, and the embedding vector of the large language model at the current time may be input into the prediction model. The embedding vector may include correlation information that characterizes the target audio features, and the prediction model may be used to output target enhancement parameters based on the associated information.

In some embodiments, the associated information may be the environmental information, scene information, etc.

The following describes the process of determining the target enhancement parameter based on the degree of matching in the second method.

### Embodiments of the Present Disclosure

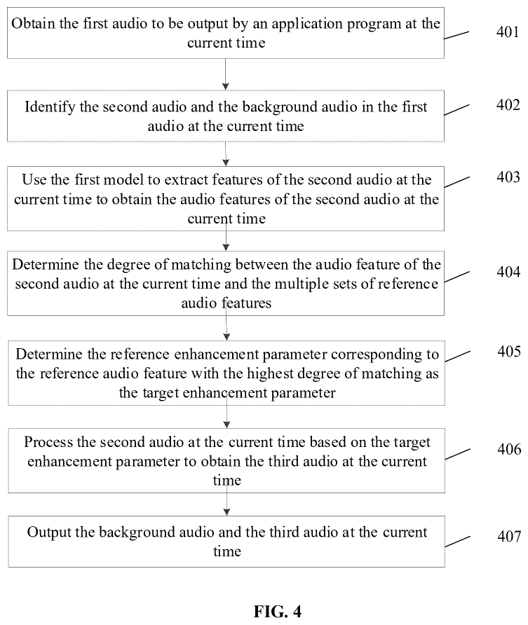

FIG. 4 is a flowchart of the audio processing method according to some embodiments of the present disclosure. The method will be described in detail below.
401, obtaining the first audio to be output by an application program at the current time.

For the implementation of the process at 401, reference can be made to the description of the process at 101, which will not be repeated here.
402, identifying the second audio and the background audio in the first audio at the current time.

For the implementation of the process at 402, reference can be made to the description of the process at 102, which will not be repeated here.
403, using the first model to extract features of the second audio at the current time to obtain the audio features of the second audio at the current time.

For the implementation of the process at 403, reference can be made to the description of the process at 203, which will not be repeated here.
404, determining the degree of matching between the audio feature of the second audio at the current time and the multiple sets of reference audio features.

In some embodiments, multiple common situations and reference enhancement parameters for each common situation may be determined in advance. A variety of common situations can be reflected by audio features, that is, each situation can correspond to an audio feature of a second audio (i.e., an audio feature), and each second audio can correspond to a reference enhancement parameter.

The electronic device may determine the degree of matching between the audio feature of the second audio at the current time and the audio feature of the second audio in each case, and obtain multiple degrees of matching.

The embodiments of the present disclosure do not limit the specific algorithm for determining the degree of matching, which can be configured based on actual needs. For example, the degree of matching can be determined based on the cosine similarity of features or an adjacency algorithm.

The embodiments of the present disclosure do not limit the determination method of the reference enhancement parameters in each case, which can be configured based on actual conditions. For example, the reference enhancement parameters can be obtained based on actual calibration values, or the reference enhancement parameters can be an empirical value, or a value obtained by an algorithm, etc.
405, determining the reference enhancement parameter corresponding to the reference audio feature with the highest degree of matching as the target enhancement parameter.

In some embodiments, the reference enhancement parameter may be used to enhance the target audio in the second audio corresponding to the reference audio feature from the first audio intensity to the second audio intensity.

The reference enhancement parameter may also be used to enhance the target audio in the second audio corresponding to the reference audio feature from the first audio intensity to the second audio intensity.

For example, assume the target audio is the sound of a gunshot. 50 sets of reference enhancement parameters can be configured for the second audio in the following common case, where the first 12 sets of reference enhancement parameters can be described in the following cases 1 to 12.

In case 1, the second audio includes the sound of a gunshot. Correspondingly, the reference audio feature 1 can represent the audio feature of the gunshot, and the corresponding reference enhancement parameter can be the reference enhancement parameter 1.

In case 2, the second audio includes the sound of a pistol. Correspondingly, the reference audio feature 2 can represent the audio feature of the sound of a pistol, and the corresponding reference enhancement parameter can be the reference enhancement parameter 2.

In case 3, the second audio includes the sound of a sniper rifle. Correspondingly, the reference audio feature 3 can represent the audio feature of the sound of a sniper rifle, and the corresponding reference enhancement parameter can be the reference enhancement parameter 3.

In case 4, the second audio includes the sound of a gunshot and the sound of raindrops. Correspondingly, the reference audio feature 4 can represent the audio features of the sound of a gunshot and the sound of raindrops, and the corresponding reference enhancement parameter can be the reference enhancement parameter 4.

In case 5, the second audio includes the sound of a gunshot and the sound of thunder. Correspondingly, the reference audio feature 5 can represent the audio features of the sound of a gunshot and the sound of thunder, and the corresponding reference enhancement parameter can be the reference enhancement parameter 5.

In case 6, the second audio includes the sound of a gunshot and the sound of wind. Correspondingly, the reference audio feature 6 can represent the audio features of the sound of a gunshot and the sound of wind, and the corresponding reference enhancement parameter can be the reference enhancement parameter 6.

In case 7, the second audio includes the sound of a gunshot in a grassy scene. Correspondingly, the reference audio feature 7 can represent the audio feature of the sound of a gunshot in the grassy scene, and the corresponding reference enhancement parameter can be the reference enhancement parameter 7.

In case 8, the second audio includes the sound of a gunshot in a desert scene. Correspondingly, the reference audio feature 8 can represent the audio feature of the sound of a gunshot in the desert scene, and the corresponding reference enhancement parameter can be the reference enhancement parameter 8.

In case 9, the second audio includes the sound of a gunshot and the sound of raindrops in a desert scene. Correspondingly, the reference audio feature 9 can represent the audio features of the sound of a gunshot and the sound of raindrops in the desert scene, and the corresponding reference enhancement parameter can be the reference enhancement parameter 9.

In case 10, the second audio includes the sound of a gunshot and the sound of raindrops in a grassy scene. Correspondingly, the reference audio feature 10 can represent the audio features of the sound of a gunshot and the sound of raindrops in the grassy scene, and the corresponding reference enhancement parameter can be the reference enhancement parameter 10.

In case 11, the second audio includes the sound of a gunshot and the sound of wind in a grassy scene. Correspondingly, the reference audio feature 11 can represent the audio features of the sound of a gunshot and the sound of wind in the grassy scene, and the corresponding reference enhancement parameter can be the reference enhancement parameter 11.

In case 12, the second audio includes the sound of a gunshot and the sound of wind in a desert scene. Correspondingly, the reference audio feature 12 can represent the audio features of the sound of a gunshot and the sound of wind in the desert scene, and the corresponding reference enhancement parameter can be the reference enhancement parameter 12.

The electronic device can match the audio features of the second audio at the current time with the reference audio feature 1, reference audio feature 2, reference audio feature 3, etc. to obtain 50 matching degrees. The reference enhancement parameter corresponding to the reference audio feature with the highest matching degree in the 50 matching degrees can be determined as the target enhancement parameter.

The matching-based implementation method has the characteristics of simple implementation logic, convenient implementation process and fast response.
406, processing the second audio at the current time based on the target enhancement parameter to obtain the third audio at the current time.

For the implementation of the process at 406, reference can be made to the description of the process at 205, which will not be repeated here.
407, outputting the background audio and the third audio at the current time.

For the implementation of the process at 407, reference can be made to the description of the process at 104, which will not be repeated here.

In this way, the target enhancement parameters can be quickly determined by the matching method. When the target audio is enhanced, it has the characteristic of fast response as the model is not required to implement a complex processing process.

It should be noted that the second audio may also be directly associated with the reference enhancement parameter. In this way, when determining the target enhancement parameter, the matching degree between the second audios can be directly determined. That is, the second audio at the current time can be matched with each historical second audio in the parameter library to obtain multiple matching degrees, and the reference enhancement parameter corresponding to the second audio with the highest matching degree can be determined as the target enhancement parameter.

The following describes the process of processing the target audio in the second audio at the current time to obtain the third audio at the current time in the process at 103. This process can include, but is not limited to, the following implementation methods.

In some embodiments, the third audio at the current time may be determined based on the second audio at the current time, the second audio and third audio at the previous time, the second audio and third audio two times before, and the target enhancement parameter.

In some embodiments, the third audio at the current time may be determined based on the second audio at the current time and the target enhancement parameter.

The following describes the process of determining the third audio at the current time based on the second audio at the current time, the second audio and third audio at the previous time, the second audio and third audio two times before, and the target enhancement parameter.

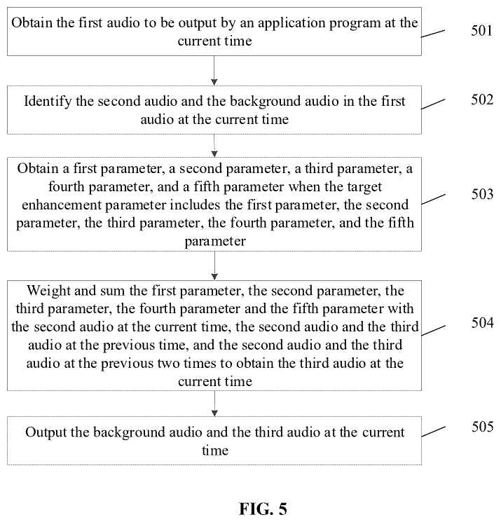

FIG. 5 is a flowchart of the audio processing method according to some embodiments of the present disclosure. The method will be described in detail below.
501, obtaining the first audio to be output by an application program at the current time.

For the implementation of the process at 501, reference can be made to the description of the process at 101, which will not be repeated here.
502, identifying the second audio and the background audio in the first audio at the current time.

For the implementation of the process at 502, reference can be made to the description of the process at 102, which will not be repeated here.
503, obtaining a first parameter, a second parameter, a third parameter, a fourth parameter, and a fifth parameter when the target enhancement parameter includes the first parameter, the second parameter, the third parameter, the fourth parameter, and the fifth parameter.

In some embodiments, the first parameter may be an input weight parameter for enhancing the target audio in the second audio. The second parameter may be the weight parameter of the second audio at the previous time. The third parameter may be the weight parameter of the third audio at the previous time. The fourth parameter may be the weight parameter of the second audio two times ago, and the fifth parameter may be the weight parameter of the third audio two times ago.

In practice, when determining the third audio at the current time, the input and output of the previous two time (that is, the second audio and the third audio at the previous two times) can be combined. In this way, the obtained third audio at the current time can avoid lag and have good sound quality.

After obtaining the target enhancement parameters, the electronic device may directly obtain the first parameter, the second parameter, the third parameter, the fourth parameter and the fifth parameter in the target enhancement parameters.
504, weighting and summing the first parameter, the second parameter, the third parameter, the fourth parameter and the fifth parameter with the second audio at the current time, the second audio and the third audio at the previous time, and the second audio and the third audio at the previous two times to obtain the third audio at the current time.

The weighted sum can be effectively integrated. The weight coefficients, i.e., the first parameter, the second parameter, the third parameter, the fourth parameter, and the fifth parameter, can be the target enhancement parameters obtained based on the model. If there is a need to adjust the parameters, the model training process can be adjusted. Of course, the enhancement parameter of the model output can be manually adjusted.
505, outputting the background audio and the third audio at the current time.

For the implementation of the process at 505, reference can be made to the description of the process at 104, which will not be repeated here.

In this embodiment, the third audio output at the current time combines the second audio at the current time, the second and third audio at the previous time, and the second and third audio at the previous two times. In this way, the third audio at the current time can be integrated with the output of the previous time and the previous two times, thereby avoiding the audio jam caused by too large a difference, making the output smoother and more fluent.

In some embodiments, the third audio at the current time may be determined based on the second audio at the current time and the target enhancement parameter. In this case, the target enhancement parameter can be directly input into the equalization filter to process the second audio at the current time through the equalization filter to obtain the third audio at the current time.

It can be seen that the implementation logic of this implementation method is simple, and the third audio at the current time can be quickly obtained with a fast response.

The following describes the process of processing the target audio in the second audio at the current time to obtain the third audio at the current time in the process at 103 from the perspective of frequency.

FIG. 6 is a flowchart of the audio processing method according to some embodiments of the present disclosure. This method can be applied when the frequency of the target audio belongs to multiple frequency bands. The method will be described in detail below.
601, obtaining the first audio to be output by an application program at the current time.

For the implementation of the process at 601, reference can be made to the description of the process at 101, which will not be repeated here.
602, identifying the second audio and the background audio in the first audio at the current time.

For the implementation of the process at 602, reference can be made to the description of the process at 102, which will not be repeated here.
603, determining the target enhancement parameter of each frequency band for each of the plurality of frequency bands.

The target enhancement parameter of each frequency band can be used to enhance the target audio in the second audio at the current time from the first audio intensity to the second audio intensity in the frequency band.

In some embodiments, one frequency band can be implemented by one filter, and the target enhancement parameter of one frequency band can be the filtering parameter of the filter.

In some embodiments, the number of frequency bands may be determined by the frequency of the defined target audio.

The corresponding method for determining the target enhancement parameter for each frequency band is similar. For details, reference can be made to the above description of determining the target enhancement parameter, which will not be repeated here.
604, processing the second audio at the current time based on at least the target enhancement parameter of each frequency band to obtain the third audio at the current time in each frequency band.

For each frequency band, the second audio of each frequency band at the current time can be processed to obtain the third audio of each frequency band at the current time. For details, reference can be made to the above description of obtaining the third audio at the current time, which will not be repeated here.
605, superimposing the third audio at the current time in each frequency band to obtain the third audio at the current time.

In some embodiments, the superposition may be based on the corresponding frequency. If the frequencies do not overlap, it is equivalent to splicing.
606, outputting the background audio and the third audio at the current time.

For the implementation of the process at 606, reference can be made to the description of the process at 104, which will not be repeated here.

In this embodiment, the target audio can be enhanced through multiple frequency bands, which makes it applicable to various sound ranges and various types of target audio enhancement, and has a wide range of applications.

The following describes the audio processing process provided in the embodiment of the present application by taking the application program of a shooting game as an example.

Currently, the sounds of gunfire and footsteps (equivalent to the target audio described above) in shooting games on tablets are relatively small, resulting in users being unable to clearly perceive the enemy's position.

In related technologies, one of the solutions is to adjust the volume of the overall music and sound effects in the game. The disadvantage of this approach is that it cannot enhance the sound of gunfire and footsteps. Another solution is to set the equalization mode for sound playback in the device system settings. The disadvantage of this approach is that this will process all played sounds, such as music, rather than specifically for games. In addition, some tablets do not have an equalization mode option for sound playback, and this approach cannot be implemented.

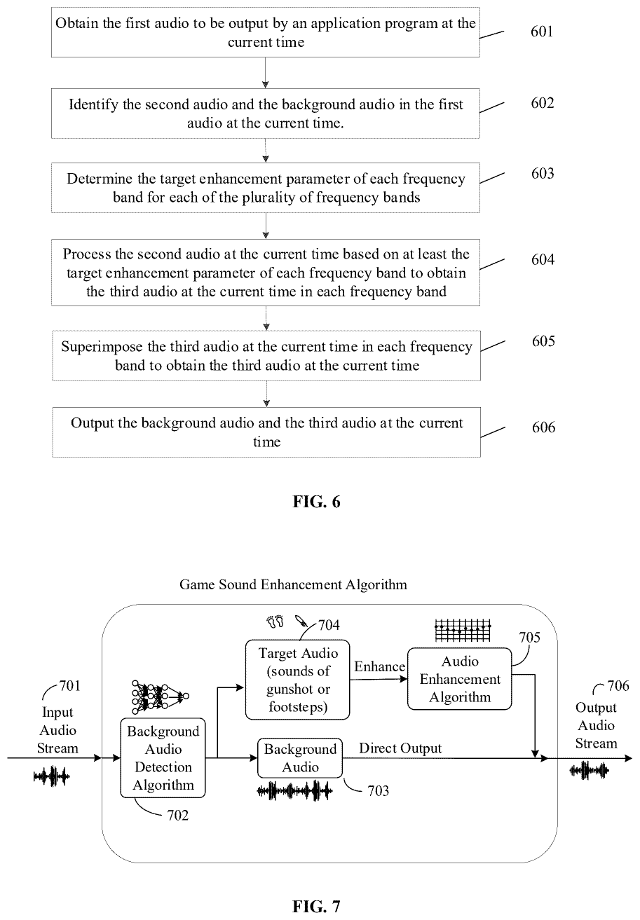

FIG. 7 is a flowchart of an audio processing process according to some embodiments of the present disclosure. The process is a general audio processing process. The process will be described in detail below.
701, inputting the audio stream.
702, performing detection using a background audio detection algorithm.
703, directly outputting the background audio.
704, inputting the target audio (e.g., the sounds of gunshots or footsteps) for enhancement.
705, enhancing the target audio using an audio enhancement algorithm.
706, outputting the audio stream.

The process of detecting the background audio will be described in detail below.

By training a neural network-based binary classification model, whether the current sound is background audio or target audio (equivalent to the second audio mentioned above) may be determined.

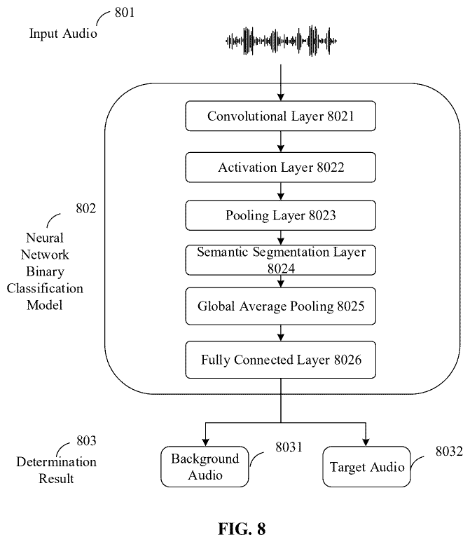

For example, the detection process may be as shown in FIG. 8. As shown in FIG. 8, audio 801 is input into a neural network binary classification model 802 for identification to obtain a determination result 803. The neural network binary classification model 802 can include a convolutional layer 8021, an activation layer 8022, a pooling layer 8023, a semantic segmentation layer 8024, a global average pooling 8025, and a fully connected layer 8026.

The determination result 803 can include the background audio 8031 or the target audio 8032.

The following describes the audio enhancement process in detail.

FIG. 9 is a schematic diagram of an audio enhancement process according to some embodiments of the present disclosure. As shown in FIG. 9, the audio (e.g., a game sound dataset) is input into a local AI large model 901. The local AI large model 901 performs speech understanding 902 on the input audio to obtain an embedding vector 903, and the local AI large model 901 performs natural language processing 904 on the embedding vector 903 to obtain an output result 905. At the same time, the local AI large model 901 inputs the embedded vector 903 into a parameter prediction model 906, and obtains an output enhancement parameter 907 through processing by the parameter prediction model 906.

Using the recorded game sound data, the local large model can be fine-tuned and trained such that the large model, which originally only has the ability to understand speech, can generate the EQ filter parameter for audio enhancement. This parameter can be used as input to the filter to enhance the target audio.

When combined with a large model, the algorithm can use the embedding vector output by the speech recognition module in the large model as the input of the subsequent parameter prediction model. This vector may include the environmental information and semantic information of the audio. If someone is speaking, it may also include gender information, emotional information, etc.

When combining the vector output by the large model and the parameter prediction model, the large model speech recognition module can be used to extract features and use the features as the input of the parameter prediction model.

Since the vector output by the large model contains rich information, the parameter prediction model can make predictions more accurate. The model mainly uses the environmental information, audio content information, scene category information, etc. in the vector. In this way, different enhancement parameters can be generated based on different scenes and different contents. For example, different types of enhancement parameters can be generated based on the sounds of gunshots and footsteps, and different parameters can be generated based on different types of gunshot sounds.

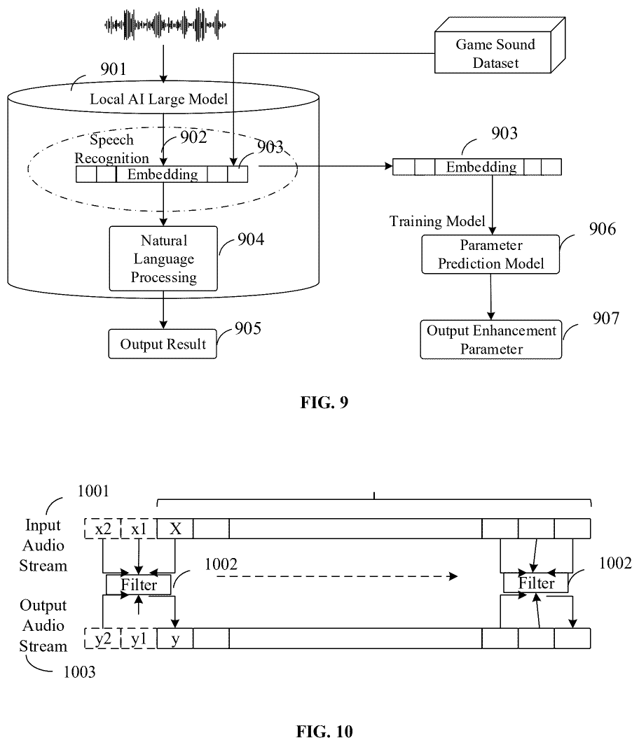

In some embodiments, the enhancement parameters output by the parameter prediction model can be applied to the filter, and the game audio can be filtered to enhance the game audio. FIG. 10 is a schematic diagram of a filtering process according to some embodiments of the present disclosure. As shown in FIG. 10, the filtering process can include inputting the data of an input buffer, that is, an input audio stream 1001, into a filter 1002, and using the filter to process the input audio stream to obtain an output audio stream 1003. In FIG. 10, x represents the current input sampling point x₍ₜ₎, x₁ represents the sampling point x₍ₜ₋₁₎ at the previous time, and x₂ represents the sampling point x₍ₜ₋₂₎ at the second time before. Similarly, y represents the output at the current time after filtering, y₁ represents the output at the previous time, and y₂ represents the output at the previous two times.

Assume that the predicted weights are a₀, a₁, a₂, b₁ and b₂, the calculation can be performed using Formula 1.

$$y = {a}_{0} \times x + {a}_{1} \times {x}_{1} + {a}_{2} \times {x}_{2} + {b}_{1} \times {y}_{1} + {b}_{2} \times {y}_{2} \qquad Formula 1$$

In Formula 1, represents the current input sampling point x₍ₜ₎, x₁ represents the sampling point x₍ₜ₋₁₎ at the previous time, and x₂ represents the sampling point x₍ₜ₋₂₎ at the second time before. Similarly, y represents the output at the current time after filtering, y₁ represents the output at the previous time, and y₂ represents the output at the previous two times.

Subsequently, the filter slides back to process the new input samples.

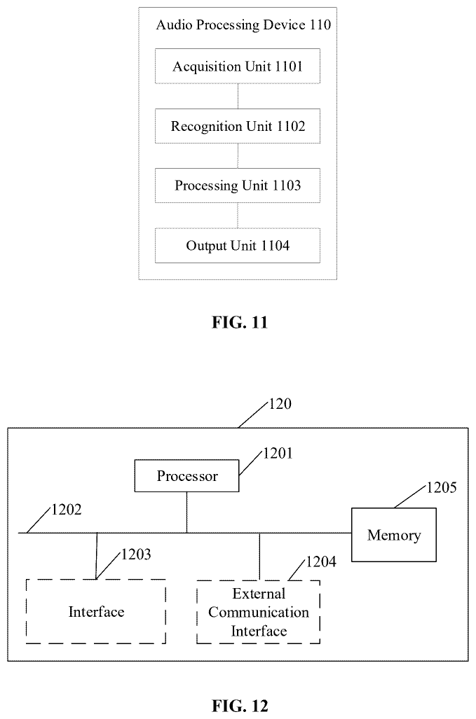

In order to implement the above audio processing method, embodiments of the present disclosure provide an audio processing device. The audio processing device may be deployed on a user terminal device. FIG. 11 is a schematic structural diagram of an audio processing device 110 according to some embodiments of the present disclosure.

As shown in FIG. 11, the audio processing device 110 includes an acquisition unit 1101, a recognition unit 1102, a processing unit 1103, and an output unit 1104.

In some embodiments, the acquisition unit 1101 may be configured to obtain the first audio to be output by the application program at the current time.

In some embodiments, the recognition unit 1102 may be configured to identify the second audio and background audio in the first audio at the current time, the second audio including the target audio generated by the simulated target object.

In some embodiments, the processing unit 1103 may be configured to process the target audio in the second audio at the current time to obtain a third audio at the current time.

In some embodiments, the output unit 1104 may be configured to output the background audio and the third audio at the current time.

In some embodiments, the target audio before processing may include a first audio intensity, and the target audio after processing may include a second audio intensity. The second audio intensity may be greater than the first audio intensity.

In some embodiments, the processing unit 1103 may be further configured to use the first model to extract features of the second audio at the current time to obtain the audio features of the second audio at the current time; determine the target enhancement parameter based on at least the audio features of the second audio at the current time; use the target enhancement parameter to enhance the target audio in the second audio at the current time from the first audio intensity to the second audio intensity; process the second audio at the current time based on the target enhancement parameter to obtain the third audio at the current time.

In some embodiments, the processing unit 1103 may be further configured to input the audio features of the second audio at the current time into the prediction model, process the audio features using the prediction model, and output the target enhancement parameter for enhancing the target audio in the second audio at the second time. The prediction model may be used to predict the enhancement parameters corresponding to the audio features for enhancing the target audio in the second audio at the current time.

In some embodiments, the prediction model may be obtained by training sets of training data. The sets of training data may include the audio features of the target audio and a first enhancement parameter, the fused audio features of the target audio and the ambient audio and a second enhancement parameter, the fused audio features of the target audio and the scene audio and a third enhancement parameter, and the fused audio features of the target audio, the ambient audio and the scene audio and a fourth enhancement parameter.

In some embodiments, the first model may be a local large language model deployed on the electronic device running the application program, the audio features of the second audio may be the embedding vector of the large language model, and the embedding vector of the large language model at the current time may be input into the prediction model. The embedding vector may include correlation information that characterizes the target audio features, and the prediction model may be used to output target enhancement parameters based on the associated information.

In some embodiments, the processing unit 1103 may be further configured to determine the degree of matching between the audio feature of the second audio at the current time and the multiple sets of reference audio features, and determine the reference enhancement parameter corresponding to the reference audio feature with the highest degree of matching as the target enhancement parameter. In some embodiments, the reference enhancement parameter may be used to enhance the target audio in the second audio corresponding to the reference audio feature from the first audio intensity to the second audio intensity.

In some embodiments, the processing unit 1103 may be further configured to determine the third audio at the current time based on the second audio at the current time, the second audio and third audio at the previous time, the second audio and third audio two times before, and the target enhancement parameter. Alternative, the processing unit 1103 may be further configured to determine the third audio at the current time based on the second audio at the current time and the target enhancement parameter.

In some embodiments, the processing unit 1103 may be further configured to obtain a first parameter, a second parameter, a third parameter, a fourth parameter, and a fifth parameter when the target enhancement parameter includes the first parameter, the second parameter, the third parameter, the fourth parameter, and the fifth parameter, and weigh and sum the first parameter, the second parameter, the third parameter, the fourth parameter and the fifth parameter with the second audio at the current time, the second audio and the third audio at the previous time, and the second audio and the third audio at the previous two times to obtain the third audio at the current time. In some embodiments, the first parameter may be an input weight parameter for enhancing the target audio in the second audio. The second parameter may be the weight parameter of the second audio at the previous time. The third parameter may be the weight parameter of the third audio at the previous time. The fourth parameter may be the weight parameter of the second audio two times ago, and the fifth parameter may be the weight parameter of the third audio two times ago.

In some embodiments, when the frequency of the target audio belongs to multiple frequency bands, the processing unit 1103 may be further configured to determine the target enhancement parameter of each frequency band for each of the plurality of frequency bands. The target enhancement parameter of each frequency band can be used to enhance the target audio in the second audio at the current time from the first audio intensity to the second audio intensity in the frequency band. In addition, the processing 1103 may be configured to process the second audio at the current time based on at least the target enhancement parameter of each frequency band to obtain the third audio at the current time in each frequency band. The third audio at the current time in each frequency band may be superimposed to obtain the third audio at the current moment.

It should be noted that all units included in the data processing device provided by the embodiments of the present disclosure may be implemented through an overall processor of a computing device, and certainly may also be implemented through a specific logic circuit. In different embodiments, the processor may be a central processor (CPU), a microprocessor (MPU), a digital signal processor (DSP), a field programmable gate array (FPGA), or the like.

It should be noted here that the descriptions of the above device embodiments are similar to the description of the above method embodiments. The device embodiments have similar advantageous effects with those of the method embodiments and thus the description thereof will be omitted here. For those technical details not mentioned in the above device embodiments, reference can be made to the description of the above method embodiments and the description thereof will be omitted here for simplicity.

It should be noted that, in the embodiments of the present disclosure, if the above data processing method is realized in the form of software function units and are sold or used as independent products, the display method can be stored in a computer-readable storage medium. On the basis of such an understanding, the technical solution of the present disclosure, in essence, encompasses all or a part of the technical solution which contributes to the conventional technology in the form of software products, which may be stored in a storage medium, including instructions to cause a computer device (a personal computer, a server, a network device, or the like) to execute the entire or a part of method consistent with the disclosure, such as one of the example methods described above. The aforementioned storage medium may include but is not limited to a medium that can store program codes, such as a universal serial bus (USB) flash drive, a read-only memory (ROM), a random-access memory (RAM), a portable hard disk, a magnetic disk or an optical disk. The embodiments of the present disclosure are not limited to any specific combination of hardware and software.

To implement the audio processing method described above, an embodiment of the present disclosure provides an electronic device including a processor and a memory. The memory stores a computer program that can be executed by the processor. When the computer program is executed by the processor, the computer program causes the processor to perform audio processing method described in the foregoing embodiments.

In some embodiments, the electronic device may include a first interface, a processor, and an output interface.

The first interface may be configured to obtain the first audio to be output by the application program at the current time.

The processor may be configured to identify the second audio and the background audio in the first audio at the current time; process the target audio in the second audio at the current time to obtain the third audio at the current time, the second audio including the target audio generated by simulating a target object. In some embodiments, the target audio before processing may include a first audio intensity, and the target audio after processing may include a second audio intensity. The second audio intensity may be greater than the first audio intensity.

The output interface may be configured to output the background audio and the third audio at the current time.

FIG. 12 is a schematic diagram of an electronic device 120 according to some embodiments of the present disclosure.

In one example, as shown in FIG. 12, the electronic device 120 includes a processor 1201, at least one communication bus 1202, an interface 1203, at least external communication interface 1204, and a memory 1205. The communication bus 1202 may be configured to enable connection communication between these components. The interface 1203 may be connected to an external display screen. The external communication interface 1204 may include the standard wired interface and wireless interface.

The memory 1205 may be configured to store instructions and applications executable by the processor 1201, and also cache the to-be-processed or processed data (e.g., image data, audio data, voice communication data, and video communication data) processed by the processor 1201 and various modules in the electronic device, which can be implemented by a flash memory or a random-access memory.

An embodiment of the present disclosure provides a storage medium, that is, a computer-readable storage medium having a computer program stored thereon. When the computer program is executed by a processor, the computer program causes the processor to perform the audio processing method provided in the foregoing embodiments.

An embodiment of the present disclosure provides a computer program product, which includes a computer program. When the computer program is executed by a processor, the computer program causes the processor to perform the audio processing method provided in the foregoing embodiments.

It should be noted here that the descriptions of the above storage medium and electronic device embodiments are similar to the description of the above method embodiments. The storage medium and electronic device embodiments have similar advantageous effects with those of the method embodiments and thus the description thereof will be omitted here. For those technical details not mentioned in the above storage medium and electronic device embodiments, reference can be made to the description of the above method embodiments and the description thereof will be omitted here for simplicity.

It is to be noted that the term “one embodiment” or “an embodiment” as used throughout the description means that the specific features, structures or characteristics associated with the embodiment are included in at least one embodiment of the present disclosure. Hence, the expression “in one embodiment” or “in an embodiment” as used throughout the description does not necessarily refer to the same embodiment. Further, these specific features, structures or characteristics can be arbitrarily combined in one or more embodiments as appropriate. It should be appreciated that, in various embodiments of the present disclosure, the numbering of the above processes does not mean the order in which they are executed. The order in which the processes are executed should be determined by their functions and internal logic, rather than being limited to any embodiment of the present disclosure. The numbering of the above embodiments is used for the purpose of illustration only, but does not imply any preference among those embodiments.

It is to be noted here that the terms “including” or “comprising” or any variants thereof as used herein are not exclusive, such that a process, method, article or apparatus including/comprising a number of elements may also include/comprise other elements that are not explicitly listed or inherent to the process, method, article or apparatus. If not limited otherwise, an element included in process, method, article or apparatus does not exclude a situation where the process, method, article or apparatus including the element further includes one or more identical elements.

It can be appreciated from the embodiments of the present disclosure that the disclosed method and device can be implemented in alternative ways. The device embodiments as described above are illustrative only. For example, while the units have been divided in accordance with their logical functions, other divisions are possible in practice. For example, more than one unit or element can be combined or can be integrated into another system, or some features can be ignored or omitted. In addition, the coupling, direct coupling or communicative connection between various components as shown or discussed can be an indirect coupling or communicative connection via some interface, device or unit and can be electrical, mechanical or in another form.

The units described above as separated may or may not be physically separated. The components shown as units may or may not be physical units. They can be co-located or can be distributed over a number of network elements. Depending on actual requirements, some or all of the units can be selected to achieve the object of the present disclosure.

Further, all the functional units in various embodiments of the present disclosure can be integrated within one processing unit, or each of these units can be a separate unit, or two or more units can be integrated into one unit. Such integrated units can be implemented in hardware, possibly in combination with software functional units.

It can be appreciated by those skilled in the art that some or all of the steps in the method embodiments described above can be implemented by hardware following instructions of a program. Such program can be stored in a computer readable storage medium and, when executed, performs the steps of the above method embodiments. The storage medium may be any of various mediums capable of storing program codes, such as a mobile storage device, a read-only memory (ROM), a random-access Memory (RAM), a magnetic disk or an optical disc.

Alternatively, when the above integrated units of the present disclosure are implemented in software functional modules and sold or used as a standalone product, they can be stored in a computer readable storage medium. In view of this, the technical solutions according to the embodiments of the present disclosure, or in other words a part thereof which makes contribution over the prior art, can be substantially embodied in a form of software product. The computer software product can be stored in a storage medium, such as ROM/RAM, magnetic disk, optical disc and the like, containing instructions which cause a computer device (which can be a personal computer, a server, a network device or the like) to perform one or more methods according to the embodiments of the present disclosure or particular parts thereof. The storage medium may be any of various mediums capable of storing program codes, such as a mobile storage device, a ROM, a RAM, a magnetic disk or an optical disc.

While the embodiments of the present disclosure have been described above, the scope of the present disclosure is not limited thereto. Various modifications and alternatives can be made by those skilled in the art without departing from the scope of the present disclosure. These modifications and alternatives are to be encompassed by the scope of the present disclosure which is only defined by the claims.

What is claimed is:

1. An audio processing method comprising:
obtaining a first audio to be output by an application program at a current time;
identifying a second audio and a background audio in the first audio at the current time, the second audio including a target audio generated by simulating a target object;
processing the target audio in the second audio at the current time to obtain a third audio at the current time; and
outputting the background audio and the third audio at the current time, wherein:
the target audio before processing has a first audio intensity, the target audio after processing has a second audio intensity, and the second audio intensity is greater than the first audio intensity.

2. The method of claim 1, wherein processing the target audio in the second audio at the current time to obtain the third audio at the current time includes:
using a first model to extract features of the second audio at the current time to obtain audio features of the second audio at the current time;
determining a target enhancement parameter based on at least the audio features of the second audio at the current time, the target enhancement parameter being used to enhance the target audio in the second audio at the current time from the first audio intensity to the second audio intensity; and
processing the second audio at the current time based on the target enhancement parameter to obtain the third audio at the current time.

3. The method of claim 2, wherein determining the target enhancement parameter based on at least the audio features of the second audio at the current time includes:
inputting the audio features of the second audio at the current time into a prediction model; and
using the prediction model to process the audio features, and outputting the target enhancement parameter for enhancing the target audio in the second audio at the current time.

4. The method of claim 3, wherein:
the prediction model is obtained based on sets of training data, and the sets of training data include audio features of the target audio and a first enhancement parameter, fused audio features of the target audio and an ambient audio and a second enhancement parameter, fused audio features of the target audio and a scene audio and a third enhancement parameter, and fused audio features of the target audio, the ambient audio, and the scene audio, and a fourth enhancement parameter.

5. The method of claim 3, wherein:
the first model is a local large language model deployed on an electronic device running the application program;
the audio features of the audio are embedding vectors of the large language model, and the embedding vectors of the large language model at the current time is input into the prediction model;
the embedding vectors include associated information characterizing the target audio features, and the prediction model is used to output the target enhancement parameter based on the associated information.

6. The method of claim 2, wherein determining the target enhancement parameter based on at least the audio features of the second audio at the current time includes:
determining a degree of matching between the audio features of the second audio at the current time and a plurality of sets of reference audio features; and
determining a reference enhancement parameter corresponding to the reference audio features with a highest degree of matching as the target enhancement parameter, wherein:
the reference enhancement parameter is used to enhance the target audio in the second audio corresponding to the reference audio features from the first audio intensity to the second audio intensity.

7. The method of claim 1, wherein processing the target audio in the second audio at the current time to obtain the third audio at the current time includes:
determining the third audio at the current time based on the second audio at the current time, the second audio and the third audio at a previous time, the second audio and the third audio at a previous two times, and the target enhancement parameter; or,
determining the third audio at the current time based on the second audio at the current time and the target enhancement parameter.

8. The method of claim 7, wherein determining the third audio at the current time based on the second audio at the current time, the second audio and the third audio at the previous time, the second audio and the third audio at the previous two times, and the target enhancement parameter includes:
obtaining a first parameter, a second parameter, a third parameter, a fourth parameter, and a fifth parameter when the target enhancement parameter includes the first parameter, the second parameter, the third parameter, the fourth parameter, and the fifth parameter; and
weighting and summing the first parameter, the second parameter, the third parameter, the fourth parameter, and the fifth parameter with the second audio at the current time, the second audio and the third audio at the previous time, the second and third audio at the previous two times to obtain the third audio at the current time, wherein:
the first parameter is an input weight parameter for enhancing the target audio in the second audio, the second parameter is a weight parameter of the second audio at the previous time, the third parameter is a weight parameter of the third audio at the previous time, the fourth parameter is a weight parameter of the second audio at the previous two times, and the fifth parameter is a weight parameter of the third audio at the previous two times.

9. The method of claim 1, wherein when a frequency of the target audio belongs to a plurality of frequency bands, processing the target audio in the second audio at the current time to obtain the third audio at the current time includes:
for each of the plurality of frequency bands, determining the target enhancement parameter for each of the frequency bands, the target enhancement parameter of each frequency band being used to enhance the target audio in the second audio at the current time from the first audio intensity to the second audio intensity in the frequency band;
respectively processing the second audio at the current time based on at least the target enhancement parameter of each frequency band to obtain the third audio at the current time in each frequency band; and
superimposing the third audio at the current time in each of the frequency bands to obtain the third audio at the current time.

10. An audio processing device comprising:
an acquisition unit, the acquisition unit being configured to obtain a first audio at the current time to be output by an application program;
a recognition unit, the recognition unit being configured to identify a second audio and a background audio in the first audio at the current time, the second audio including a target audio generated by simulating a target object;
a processing unit, the processing unit being configured to process the target audio in the second audio at the current time to obtain a third audio at the current time; and
an output unit, the output unit being configured to output the background audio and the third audio at the current time, wherein:
the target audio before processing has a first audio intensity, the target audio after processing has a second audio intensity, and the second audio intensity is greater than the first audio intensity.

11. The device of claim 10, wherein the processing unit is further configured to:
use a first model to extract features of the second audio at the current time to obtain audio features of the second audio at the current time;
determine a target enhancement parameter based on at least the audio features of the second audio at the current time, the target enhancement parameter being used to enhance the target audio in the second audio at the current time from the first audio intensity to the second audio intensity; and
process the second audio at the current time based on the target enhancement parameter to obtain the third audio at the current time.

12. The device of claim 11, wherein the processing unit is further configured to:
input the audio features of the second audio at the current time into a prediction model; and
use the prediction model to process the audio features, and outputting the target enhancement parameter for enhancing the target audio in the second audio at the current time.

13. The device of claim 12, wherein:
the prediction model is obtained based on sets of training data, and the sets of training data include audio features of the target audio and a first enhancement parameter, fused audio features of the target audio and an ambient audio and a second enhancement parameter, fused audio features of the target audio and a scene audio and a third enhancement parameter, and fused audio features of the target audio, the ambient audio, and the scene audio, and a fourth enhancement parameter.

14. The device of claim 12, wherein:
the first model is a local large language model deployed on an electronic device running the application program;
the audio features of the audio are embedding vectors of the large language model, and the embedding vectors of the large language model at the current time is input into the prediction model;
the embedding vectors include associated information characterizing the target audio features, and the prediction model is used to output the target enhancement parameter based on the associated information.

15. The device of claim 11, wherein the processing unit is further configured to:
determine a degree of matching between the audio features of the second audio at the current time and a plurality of sets of reference audio features; and
determine a reference enhancement parameter corresponding to the reference audio features with a highest degree of matching as the target enhancement parameter, wherein:
the reference enhancement parameter is used to enhance the target audio in the second audio corresponding to the reference audio features from the first audio intensity to the second audio intensity.

16. The device of claim 10, wherein the processing unit is further configured to:
determine the third audio at the current time based on the second audio at the current time, the second audio and the third audio at a previous time, the second audio and the third audio at a previous two times, and the target enhancement parameter; or,
determine the third audio at the current time based on the second audio at the current time and the target enhancement parameter.

17. The device of claim 16, the processing unit is further configured to:
obtain a first parameter, a second parameter, a third parameter, a fourth parameter, and a fifth parameter when the target enhancement parameter includes the first parameter, the second parameter, the third parameter, the fourth parameter, and the fifth parameter; and
weight and sum the first parameter, the second parameter, the third parameter, the fourth parameter, and the fifth parameter with the second audio at the current time, the second audio and the third audio at the previous time, the second and third audio at the previous two times to obtain the third audio at the current time, wherein:
the first parameter is an input weight parameter for enhancing the target audio in the second audio, the second parameter is a weight parameter of the second audio at the previous time, the third parameter is a weight parameter of the third audio at the previous time, the fourth parameter is a weight parameter of the second audio at the previous two times, and the fifth parameter is a weight parameter of the third audio at the previous two times.

18. The device of claim 10, wherein when a frequency of the target audio belongs to a plurality of frequency bands, the processing unit is further configured to:
for each of the plurality of frequency bands, determine the target enhancement parameter for each of the frequency bands, the target enhancement parameter of each frequency band being used to enhance the target audio in the second audio at the current time from the first audio intensity to the second audio intensity in the frequency band;
respectively process the second audio at the current time based on at least the target enhancement parameter of each frequency band to obtain the third audio at the current time in each frequency band; and
superimpose the third audio at the current time in each of the frequency bands to obtain the third audio at the current time.

19. An electronic device comprising:
a first interface, the first interface being configured to obtain a first audio at the current time to be output by an application program;
a processor, the processor being configured to identify a second audio and a background audio in the first audio at the current time, and process the target audio in the second audio at the current time to obtain a third audio at the current time, the second audio including a target audio generated by simulating a target object; and
an output interface, the output interface being configured to output the background audio and the third audio at the current time, wherein:
the target audio before processing has a first audio intensity, the target audio after processing has a second audio intensity, and the second audio intensity is greater than the first audio intensity.

20. The device of claim 10, wherein the processor is further configured to:
use a first model to extract features of the second audio at the current time to obtain audio features of the second audio at the current time;
determine a target enhancement parameter based on at least the audio features of the second audio at the current time, the target enhancement parameter being used to enhance the target audio in the second audio at the current time from the first audio intensity to the second audio intensity; and
process the second audio at the current time based on the target enhancement parameter to obtain the third audio at the current time.
